(19) United States
(12) Patent Application Publication
(10) Pub. No.: US 2025/0282683 A1
(43) Pub. Date: Sep. 11, 2025

(54) BRINE-REINFORCED GEOPOLYMER COMPOSITION

(71) Applicant: Khalifa University of Science and Technology, Abu Dhabi (AE)

(72) Inventors: Fawzi BANAT, Abu Dhabi (AE); Thanigaivelan ARUMUGHAM, Abu Dhabi (AE); Rambabu KRISHNAMOORTHY, Abu Dhabi (AE); Shadi W. HASAN, Abu Dhabi (AE); Ali Abdulkareem ALHAMMADI, Abu Dhabi (AE)

(21) Appl. No.: 18/598,675

(22) Filed: Mar. 7, 2024

(51) Int. Cl. C04B 28/00; C04B 14/04; C04B 22/06; C04B 103/10; C04B 111/00

(52) U.S. Cl. CPC C04B 28/006; C04B 14/045; C04B 22/062; C04B 2103/10; C04B 2111/0075

(57) ABSTRACT

A geopolymer composition includes a three-dimensional (3D) alumino-silicates framework and brine embedded within the 3D alumino-silicates framework. The 3D alumino-silicates framework is formed by reacting fly ash and kaolin with an alkali activator solution. In some embodiments, the geopolymer composition can be in the form of a brick paver that is suitable for use in construction or landscaping. The brine-reinforced geopolymer brick paver is mechanically robust and stable, while making use of an undesirable waste byproduct (brine) that would otherwise have to be treated or disposed of. In some embodiments, an amount of brine in the geopolymer brick paver is between about 10 and about 40 weight percent of the total weight of the brick paver. The geopolymer brick paver can be formed using a sol-gel process at low temperatures.

### BACKGROUND

The escalating global demand for clean and safe drinking water has driven the evolution of seawater desalination technology. The desalination process effectively provides clean, portable water by eliminating salts from saline water using membrane and thermal processes. However, the desalination process results in high salinity brine waste, which is a byproduct of seawater desalination that is denser than normal seawater.

As desalination efforts increase, with the Middle East and Africa contributing significantly to the production of desalinated water, disposal of the brine waste raises environmental concerns. The brine commonly contains potentially unsafe or perilous chemicals, which may pose a threat to marine ecosystems. In many cases, the brine waste must be treated, which is expensive and burdensome, before being recycled or disposed of.

It would be beneficial to incorporate brine waste into a high strength material, such as those used in construction or landscaping, such that the brine is effectively retained within the material and does not need to be otherwise disposed of.

### SUMMARY

According to one aspect, a geopolymer composition includes a three-dimensional (3D) alumino-silicates framework and brine embedded within the 3D alumino-silicates framework. The geopolymer composition is formed through a molding process and the geopolymer composition exhibits high mechanical strength and water stability.

According to another aspect, a brick paver for landscaping or construction includes a three-dimensional (3D) alumino-silicates framework and brine embedded within the 3D alumino-silicates framework. The 3D alumino-silicates framework is formed by reacting fly ash and kaolin with an alkali activator solution.

According to another aspect, a method of making a geopolymer brick paver using solid brine waste includes creating a paste by combining solid brine waste, fly ash, kaolin and an alkali activator. The method further includes transferring the paste to a mold to solidify the paste into a solid material and curing the solid material to form the brick paver.

This summary is intended to provide an overview of subject matter of the present disclosure. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed herein.

FIG. 1 is a flowchart illustrating a process for forming a geopolymer composition.

FIG. 2 is a schematic illustrating the reaction steps that occur during the process of FIG. 1.

FIG. 3 is a schematic of an exemplary geopolymer brick paver.

FIG. 4 is a schematic of a brick walkway formed of a plurality of the brick paver of FIG. 3.

FIG. 5 is a schematic of an exemplary miniature toy or figurine formed of a geopolymer composition.

FIG. 6 is a schematic illustrating a sol-gel process for forming the geopolymer composition.

FIG. 7A is an X-ray powder diffraction (XRD) spectrum of kaolin.

FIG. 7B is a scanning electron microscope (SEM) image of kaolin.

FIG. 7C is a Fourier-transform infrared spectroscopy (FTIR) analysis of kaolin.

FIG. 8A is a scanning electron microscope (SEM) image of fly ash

FIG. 8B is an X-ray powder diffraction (XRD) spectrum of fly ash.

FIG. 8C is a Fourier-transform infrared spectroscopy (FTIR) analysis of fly ash.

FIG. 9A is an X-ray powder diffraction (XRD) spectrum of brine waste.

FIG. 9B is a scanning electron microscope (SEM) image of brine waste.

FIG. 9C is a Fourier-transform infrared spectroscopy (FTIR) analysis of brine waste.

FIG. 10A is a scanning electron microscope (SEM) image of a first (surface) layer of a geopolymer brick paver.

FIG. 10B is a scanning electron microscope (SEM) image of a second (inner) layer of the geopolymer brick paver of FIG. 10A.

FIG. 10C is a scanning electron microscope (SEM) image of a third (inner) layer of the geopolymer brick paver of FIG. 10A.

FIG. 10D is a scanning electron microscope (SEM) image of a fourth (inner) layer of the geopolymer brick paver of FIG. 10A.

FIG. 11A is a plot of compressive strength of a geopolymer composition containing 30 percent (by weight) of brine.

FIG. 11B is a plot of compressive strength of a geopolymer composition containing 40 percent (by weight) of brine.

### DETAILED DESCRIPTION

The present disclosure is directed to a novel geopolymer composition and a manufacturing process to create geopolymer paver bricks (or brick pavers) that exhibit remarkable properties suitable for the effective utilization of brine waste. In other embodiments, the geopolymer composition is a solid object that can be used for décor or crafting. In other embodiments, the solid object is a miniature toy or figurine. The geopolymer composition is a combination of solid brine waste, clay materials (fly ash and kaolin), and an alkali activator. Such combination results in a geopolymer matrix that effectively immobilizes sodium (Na⁺) and chloride (Cl⁻) ions. The geopolymer matrix results in a paver brick or brick paver with exceptional mechanical strength, durability, and water stability. This makes the paver brick well suited for various construction applications, such as landscape materials, ensuring that the brick can withstand the rigors of real-world use. By incorporating brine waste into the paver brick composition, the geopolymer composition offers a sustainable waste management solution of a problematic waste stream. The paver brick effectively retains brine by providing a physical structure (the geopolymer matrix) that can hold or trap the brine, thus immobilizing the brine components. The use of brine-reinforced geopolymer brick pavers can tie the construction and waste management sectors together, particularly as the markets for sustainable construction materials and waste management solutions both continue to grow.

The combination of geopolymerization with the utilization of brine waste results in a novel high strength and water-stable brine-reinforced geopolymer paver brick material. Geopolymers involve dissolution-condensation reactions between alumino-silicate materials under high alkaline conditions. The resulting three-dimensional network structure, akin to natural zeolites, provides exceptional hardening at room temperature.

The present disclosure addresses the urgent need to manage brine waste generated by desalination processes and use the brine waste as a valuable precursor to enhance the mechanical strength and water stability of paver bricks. Thus, the present disclosure capitalizes on the unique properties of geopolymers while incorporating brine waste to create sturdy paver bricks, contributing to efficient utilization of waste resources and sustainable development. The significance of this is underscored by the urgency of protecting marine environments from brine waste pollution while simultaneously addressing the needs of the construction industry. Bridging the gap between waste management and construction, brine-reinforced geopolymer paver bricks aim to be a transformative advancement, offering enhanced mechanical properties while developing/leading the way for prudent brine management techniques.

The brine-reinforced geopolymer composition includes solid brine waste and silicon aluminum raw materials. The combination of materials results in a geopolymer having a robust three-dimensional network structure with alumino-silicate functional groups, achieved through the use of silicon aluminum raw materials, like fly ash and kaolin. The silicon aluminum raw materials can also be referred to herein as clay materials. The fly ash and kaolin may have some synergistic combination. The fly ash provides mechanical strength to the geopolymer and the kaolin acts as a binder in the geopolymer. The brine-reinforced geopolymer composition includes a three-dimensional (3D) alumino-silicates framework in which the brine is trapped or embedded into the 3D framework.

As used herein, “brine waste” or “solid brine” or “brine solid waste” refers to the waste generated during a desalination process of seawater, employing either thermal or reverse osmosis methods.

In some embodiments, an amount of brine waste in the geopolymer brick paver or geopolymer composition is between about 10 and about 40 weight percent of the total weight of the brick paver, and an amount of clay materials in the geopolymer brick paver is between about 60 and about 70 weight percent of the total weight of the brick paver. The brine waste and clay materials are combined with an alkali activator, such as, for example, sodium hydroxide and sodium silicate, to form a geopolymer matrix. The silica source can provide additional strength to the geopolymer. The geopolymer matrix effectively immobilizes sodium and chloride ions. The geopolymer reaction results in a homogenous or densified surface layer on the brick paver which facilitates effective brine confinement. In the geopolymer brick paver, the brine functions as an additive. As such, other additives are not needed in the geopolymer composition.

In addition to brine confinement or retention, the geopolymer brick paver has high water stability and effective water absorption. As provided in detail below, an amount of the various components in the composition can be used to control the material properties of the geopolymer.

Although the geopolymer composition is commonly referred to herein as a paver brick or a brick paver, the geopolymer composition can be used in a variety of applications and industries given its mechanical properties and water stability. The geopolymer composition can be a solid object that is used in crafting or décor. The geopolymer composition can be a miniature toy or figurine. The geopolymer composition is not limited to the physical structures (size and shape) described or shown herein. A variety of sizes and shapes can be used in addition to what is described and shown herein.

Construction Industry: The brine-reinforced geopolymer paver bricks can be utilized for various construction projects, including pathways, pavements, driveways, and landscaping. These bricks exhibit improved mechanical strength, durability, and water stability, providing a sustainable and effective alternative to traditional brick materials.

Environmental Remediation: Given the ability of the paver bricks to effectively arrest brine, the geopolymer composition can be applied in areas where brine disposal is a concern, such as near desalination plants and industrial facilities. This can mitigate environmental impacts.

Infrastructure Development: The enhanced properties of the paver bricks make them suitable for infrastructure projects, including road construction and urban development. The durability and resistance of the geopolymer composition to environmental factors can extend the lifespan of infrastructure components.

Coastal and Marine Engineering: The geopolymer composition can be used in coastal protection projects, creating barriers against erosion. The brine retention capability of the paver bricks adds an extra layer of environmental safety in such applications.

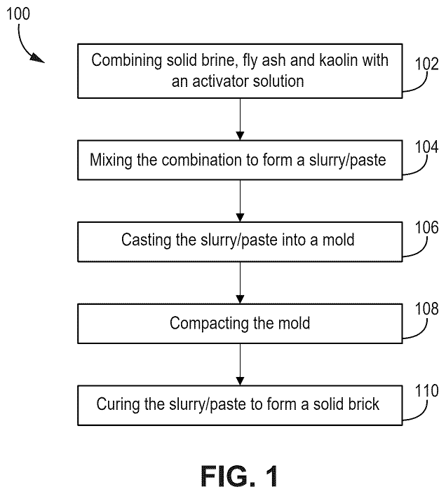

FIG. 1 illustrates a process 100 for forming a geopolymer brick paver. The process 100 includes at step 102 combining solid brine waste, fly ash and kaolin with an activator solution. The solid brine waste, fly ash and kaolin can first be combined and optionally mixed together, prior to adding the activator solution. The combination forms a cementitious powder. At step 104, all the components, including the activator solution, are mixed to form a uniformly mixed slurry/paste. Water can also be added at step 104 with the activator solution. The components may be mixed at step 104 at a low speed to prevent air bubbles, particularly since the slurry may be quite viscous. In some embodiments, the combination in step 104 is mixed for about 10 minutes. In other embodiments, the combination can be mixed for more or less time than 10 minutes,

In other embodiments, steps 102 and 104 can be a single step such that the components are combined as they are being mixed.

At step 106, the slurry/paste can be cast into a mold. A size and shape of the mold can correspond with the size and shape of the brick paver. In some embodiments, the brick paver can be used as a landscaping material. In some embodiments, the landscape paver can be a hexagon and thus the mold can be hexagon shaped. The mold can be formed of any suitable material that can releasably contain the slurry/paste. In an example, a silicone or silicone-coated mold can be used. In an example, the mold can be formed of polydimethylsiloxane (PDMS). At step 108, the mold containing the slurry/paste can be compacted using, for example, a vibrating table.

At step 110, the slurry/paste can be cured to form the solid brick paver. The curing process under step 110 can include thermal treatment of the slurry/paste. Such thermal treatment can take place at relatively low temperatures. In some embodiments, two stages of curing are used. In a first stage, the slurry can be cured at room temperature for one or more hours with the slurry remaining inside the mold. In some embodiments, the time period under the first stage can be between about 3 and about 8 hours, between about 4 and about 7 hours, and between about 5 and about 6 hours. In a second stage, the partially cured brick paver can be demolded from the mold and then cured at an elevated temperature (defined as being significantly higher than room temperature) for an extended period of time. In some embodiments, the time period under the second stage can be between about 12 hours and about five days. In some embodiments, the time period can be about three days. In some embodiments, the elevated temperature can be between about 30 and about 50 degrees Celsius. In some embodiments, the elevated temperature can be about 40 degrees Celsius.

The method 100 includes slow heating and/or gradual drying during the curing process in order to avoid or minimize the formation of cracks in the resulting solid brick paver.

In some embodiments, the method 100 can include a tumbling process. For example, at step 102, combining the dry components (brine, fly ash and kaolin) can include tumbling the dry components using, for example, a multifunctional crusher or grinder.

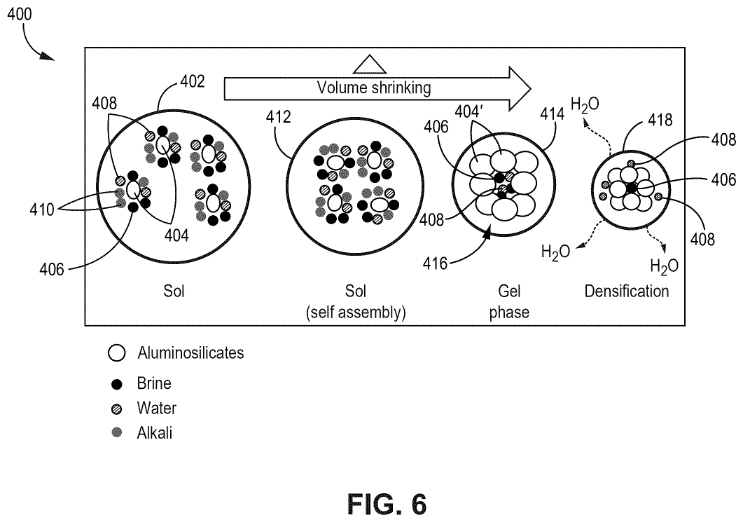

In some embodiments, the method 100 is a sol-gel process for forming the solid brick. The sol-gel process is illustrated schematically in FIG. 6 and described below.

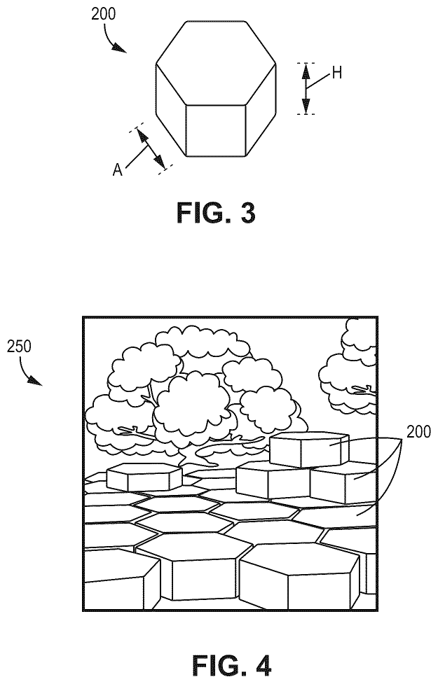

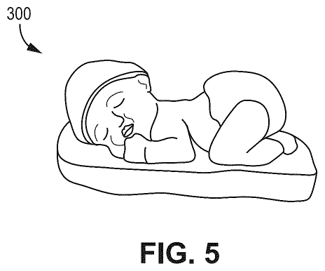

The method 100 is described above in the context of forming a brick paver. See FIGS. 3 and 4. In other embodiments, the method 100 can be used to form other solid materials, such as, for example, miniature toys or decorative items. Sec, for example, FIG. 5.

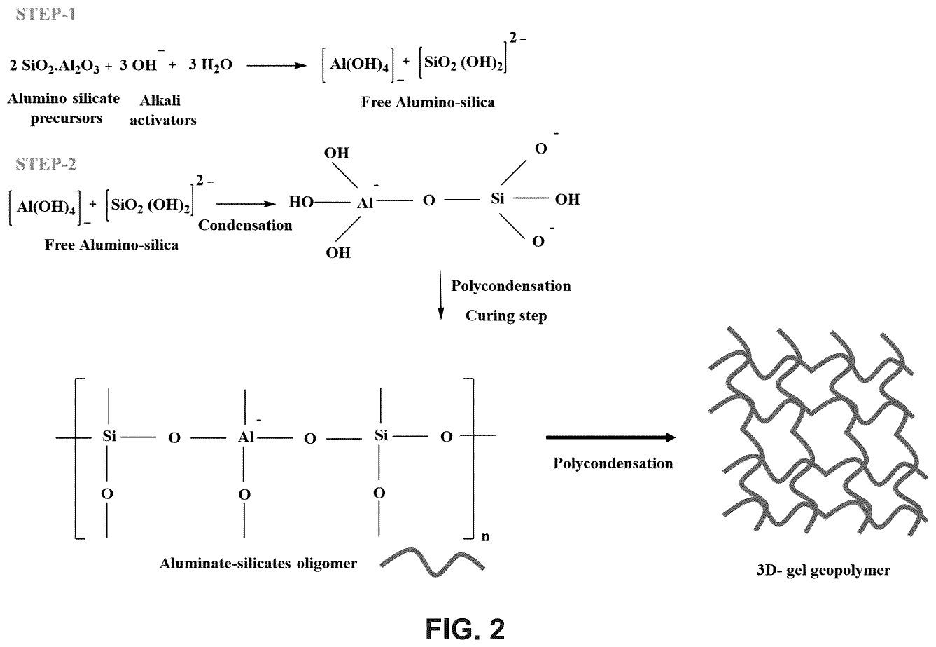

FIG. 2 illustrates compositional changes or the reaction steps during formation of the geopolymer using method 100 of FIG. 1. Under Step-1, the alumino-silicate precursors (the raw silicon aluminum materials) react with the alkali activators (in the presence of water) to form free alumino-silica. Next, under Step-2, the free alumino-silica undergoes a condensation reaction to form an aluminate-silicate monomer. A first polycondensation reaction (oligomerization) occurs to form an aluminate-silicates oligomer, followed by a second polycondensation reaction (polymerization) to form the 3D-gel geopolymer.

To develop a geopolymer of sufficient strength, stability and brine retention, the amounts of the various components that are mixed together to form the combination in steps 102 and 104 of the method 100 are controlled. In some embodiments, the amounts of a particular component are controlled relative to one or more other components.

In some embodiments, an amount of brine used in the combination is between about 10 and about 40 percent (by weight) relative to a sum (by weight) of brine, fly ash and kaolin in the combination. In some embodiments, the amount of brine used in the combination is between about 20 and about 40 percent, between about 20 and about 30 percent, or between about 30 and about 40 percent. In some embodiments, the amount of brine is about 20 percent, about 25 percent or about 30 percent.

In some embodiments, a ratio (by weight) of fly ash to kaolin used in the combination is between about 2.25:1 and about 2.40:1 or between about 2.30:1 and 2.35:1.

In some embodiments, a ratio (by weight) of sodium silicate to sodium hydroxide in the alkali activator solution used in the combination is between about 2.15:1 and about 2.30:1 or between about 2.20:1 and about 2.25:1.

In some embodiments, a ratio (by weight) of alkali activators to the silicon aluminum raw materials used in the combination is between about 0.3:1 and about 0.5:1, between about 0.35:1 and about 0.45:1, or between about 0.37:1 and about 0.42:1. In some embodiments, the ratio of a first sum of sodium silicate and sodium hydroxide to a second sum of fly ash and kaolin is between about 0.37:1 and about 0.42:1. In some embodiments, the ratio is 0.4.

In some embodiments, a ratio (by weight) of water to a sum of fly ash and kaolin in the combination is between about 0.20:1 and about 0.35:1 or between about 0.25:1 and about 0.30:1.

The combination of raw materials (fly ash, kaolin and brine), as well as the amounts of such raw materials relative to one another, results in the structural integrity of the geopolymer. The use of the alkali activator and the polymerization process for forming the geopolymer results in a homogeneous or densified surface layer and heterogenous inner layers that include entrapped brine.

FIG. 3 is a schematic of an exemplary brick paver 200 formed using the method 100 of FIG. 1. The brick paver 200 is a hexagon shape with sharp edges and corners, having a height H and a side length or base edge, A. In some embodiments, the height H and the side length λ can be equal or about equal. In an example, the height H is about 45 mm and the side length A is about 45 mm. In another example, the height H can range between about 30 and about 100 mm, and the side length A can range between about 30 and about 100 mm. In other examples, the brick paver 200 can be larger or smaller. In some embodiments, the height H and the side length A can be different from one another.

In other embodiments, the brick paver 200 can have alternative shapes to the hexagon shown in FIG. 3. The size and shape selected can depend, in part, on a particular use of the brick paver 200.

FIG. 4 is a schematic of a brick walkway 250 being formed through the assembly of a plurality of brick pavers 200. As shown by FIG. 4, the brick pavers 200 of FIG. 3 are well suited for use in forming patios, walkways, sidewalks or driveways. Similarly, the brick pavers 200 can be used in other landscape applications, such as for retention walls. As described in the Examples section below, the brick pavers 200 have sufficient strength and stability for use in landscape and construction applications. Brick pavers having different shapes and sizes than what is shown specifically in FIG. 4 are within the scope of the present application and can be formed using the methods described herein, including the method 100 of FIG. 1.

FIG. 5 is another example of a geopolymer composition 300, which is a miniature toy or figurine 300. FIG. 5 illustrates one example of the type of shape or design of a solid geopolymer composition formed using the method 100 of FIG. 1. In other examples, a geopolymer composition can be used for creating solid objects for crafting or décor. In some embodiments, the geopolymer composition 300 can be painted or otherwise customized after the solid composition is formed.

In some embodiments, the brick paver 200 or the composition 300 can be painted or coated after formation. All or a portion of the paver 200 or composition 300 can be painted with one or more colors. Alternatively, other processes (for example, dyes) can be used to add one or more colors to all or a portion of the paver 200 or composition 300. Similarly, a coating can be applied to the paver 200 or composition 300.

The brine-reinforced geopolymer composition of the present application is not limited to the examples or application areas specifically described herein. Since the geopolymer composition can be formed through a casting process, numerous applications are possible. The mold used in the casting process can be customized or tailored to the size and shape for the specific application.

FIG. 6 is a schematic illustrating a sol-gel process 400 for forming the geopolymer composition, including the brine retention mechanism that results from the process 400. In an initial stage 402, aluminosilicate precursors 404 (fly ash and kaolin) are in a colloidal solution (sol) with brine 406, water 408, and alkali activator 410. As shown by a second stage 412, the sol starts to self-assemble as the aluminosilicate precursors 404 arrange themselves relative to one another,

The alkali activator 410 functions in activating the gel structure such that the colloidal solution begins to form a gel at a third stage 414 (condensation) and the aluminosilicates 404′ (which are no longer precursors) form a three-dimensional network 416. As shown in FIG. 6, in the third stage 414, the brine 406 and water 408 get trapped within the three-dimensional network 416.

Under a fourth and final stage 418, the water 408 can be removed via the drying or curing process. This thermal treatment in the final stage 418 includes polycondensation, which results in shrinkage and densification, without requiring high temperatures. Polycondensation/densification also leads to enhanced mechanical properties of the resulting geopolymer composition. As shown in FIG. 6, the water is removed from the geopolymer network, while the brine 406 remains embedded or trapped within the geopolymer network.

The following Examples are intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### EXAMPLES

### Materials

Kaolin powder was obtained from Thermo Scientific Chemicals, UK for kaolin characterization.

Fly ash was obtained from Hebei Mcmani Mineral Products Co. Lts, China for fly ash characterization.

Sodium Silicate 40% (Water Glass) was procured from DUBICHEM Marine International EST, Fujairah, United Arab Emirates, while sodium hydroxide (pellets, 98%) was acquired from Thermo Scientific Chemicals, UK.

The brine waste was sourced from Emirates Water and Electricity Company (EWEC) and derived from seawater desalination. The brine waste was received in solution form with a solid content of approximately 10 wt. % and a pH of approximately 8. Evaporation was used to produce the solid brine used in Example 4.

No further treatment or modification was undertaken on the raw materials and chemicals employed in this invention.

### Example 1—Kaolin Characterization

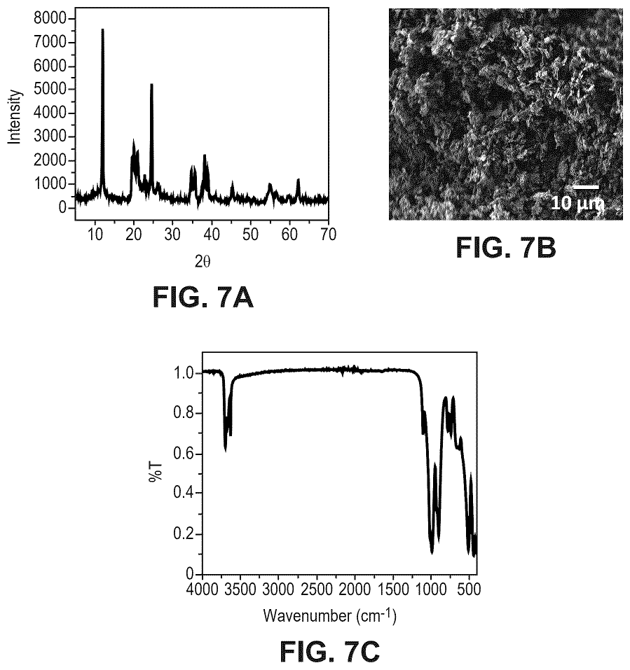

To characterize the kaolin raw material, FIGS. 7A-7C show XRD spectrum for mineralogical composition, SEM for structural attributes and FTIR for chemical functional evaluation. The XRD data of FIG. 7A verifies the existence of crystalline phases, with major peaks emerging at 2⊖=12, 24°, and 38°. The characteristic micro-sheet like structure of kaolin is visible in FIG. 7B. Vibrational stretches of —OH groups are expressed in the absorption band at 3688-3619 cm⁻¹ in FIG. 7C. The presence of the Al—OH bond vibration is denoted by the 904 cm⁻¹ peak in FIG. 7C. Additionally, vibrations of the Si—O—Si bond are discerned in the peaks at 1117, 1001, and 527 cm⁻¹.

### Example 2—Fly Ash Characterization

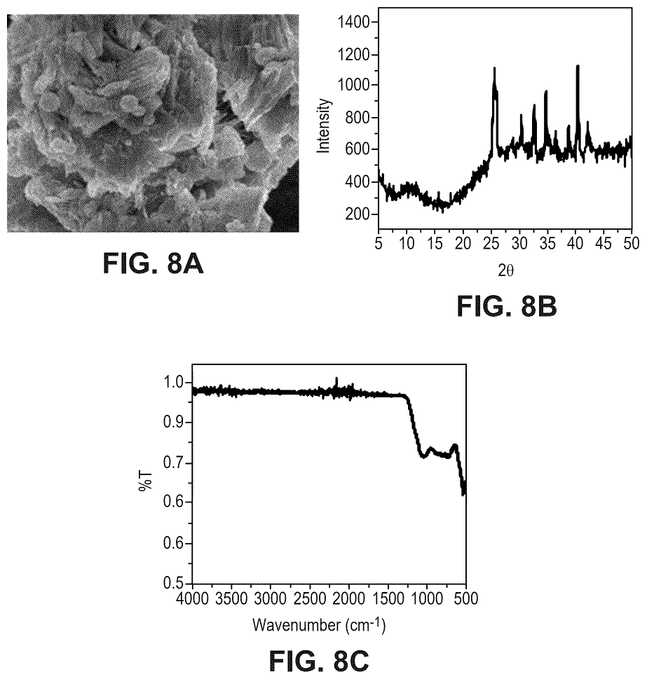

Characterization of the fly ash raw material involved scanning electron microscopy (SEM) (FIG. 8A) for structural attributes, X-ray diffraction (XRD) for mineralogical composition (FIG. 8B), and Fourier-transform infrared spectroscopy (FT-IR) (FIG. 8C) for chemical functional evaluation. The XRD peaks in FIG. 8B are linked to mullite (3Al₂O₃·2SiO₂) and quartz (SiO₂). The SEM image of fly ash (FIG. 8A) reveals mullite and quartz with distinctive rod-like and beads-like morphologies. FT-IR Peaks in FIG. 8C associated with Al—O/Si—O bonds within the 1100-545 cm⁻¹ range are observed in silica and alumina.

### Example 3—Brine Waste Characterization

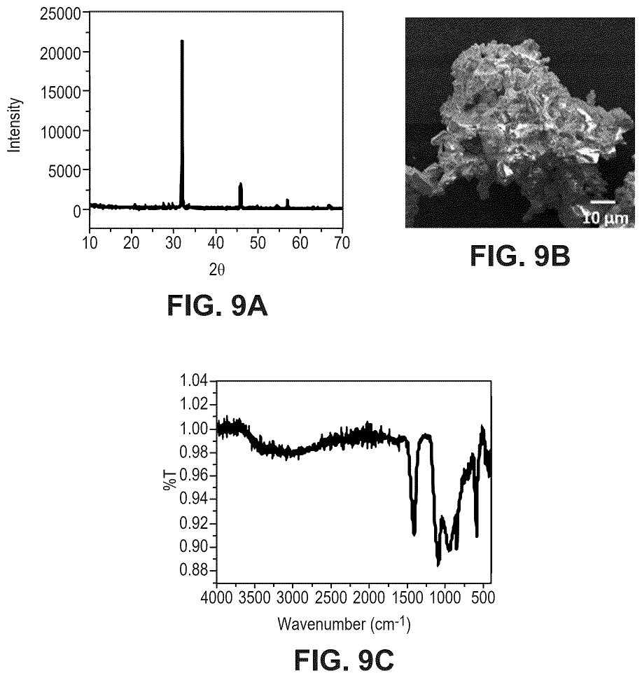

FIG. 9A shows the X-ray powder diffraction (XRD) spectrum of brine waste. FIG. 9B shows the SEM depiction of brine waste, and FIG. 9C shows the FTIR analysis of brine waste. Pronounced XRD peaks located at 2θ values of 31, 45, and 56° establish sodium chloride (NaCl) as the dominant phase in the brine, as per JCPDS card no 00-005-0628. The brine solid exhibits cubic, rough, and agglomerated crystalline structures. Notably, strong FTIR peaks in FIG. 9C at 1104, 960, and 875 cm⁻¹ confirm the presence of potential organic impurities.

Analyses consistent with American Public Health Association (APHA) standards, namely 3120 b & 3030 e: 2017 23rd edition, APHA 4500-CL, HACH 8051 Edition 11, HACH 8029 Edition 10, and HACH 8171 Edition 09, were conducted to ascertain the composition of the brine waste. Table 1 below illustrates the composition, with the prevalence of ions as Cl>Na>SO₄>Mg>Ca>K. The brine solution exhibits a solid content of approximately 10 wt. % and maintains a pH of about 8.

TABLE 1
Chemical Composition of Brine Waste

| | | Concentration |
|---|---|---|
| S. No. | Parameters | (mg/L) |
| 1 | pH | ~8 |
| 2 | Total solids (wt. %) | 8.9 |
| 3 | Calcium (Ca) | 872 |
| 4 | Magnesium (Mg) | 2640 |
| 5 | Iron (Fe) | <0.002 |
| 6 | Sodium (Na) | 13540 |
| 7 | Potassium (K) | 151 |
| 8 | Chromium (Cr) | <0.003 |
| 9 | Cadmium (Cd) | <0.002 |
| 10 | Nickel (Ni) | <0.002 |
| 11 | Zinc (Zn) | <0.004 |
| 12 | Lead (Pb) | <0.004 |
| 13 | Copper (Cu) | <0.002 |
| 14 | Manganese (Mn) | <0.002 |
| 15 | Chloride (Cl) | 26894 |
| 16 | Sulphate (SO₄) | 4000 |
| 17 | Fluoride (F) | <0.02 |
| 18 | Nitrate (NO₃) | <0.1 |

Notably, chloride (Cl) was the dominate ion present (by a significant amount), followed by sodium (Na), also at a significant ion concentration. Next to follow was sulphate (SO4), magnesium (Mg), calcium (Ca) and potassium (K).

### Example 4—Brine-Reinforced Geopolymer Brick Paver

Various geopolymer brick pavers were made with differing amounts of brine. The amount of the other components used to form the brine-reinforced geopolymer brick paver (fly ash, kaolin, alkali activator and water) were fixed. The proportions of the components are shown in Table 2 below.

TABLE 2
Ratios of components in the test samples

| | | | | Raw materials | |
|---|---|---|---|---|---|
| | (Alkali | Water/ | Alkali | | Brine/(Fly |
| | activators) | (Fly | activators/ | | ash + |
| | Na₂SiO₃/ | ash + | Fly ash + | Fly ash/ | Kaolin + |
| SAMPLE | 14M NaOH | Kaolin) | Kaolin | Kaolin | Brine) (%) |
| S 10 | 2.22 | 0.27 | 0.40 | 2.33 | 10 |
| S 20 | 2.22 | 0.27 | 0.40 | 2.33 | 20 |
| S 30 | 2.22 | 0.27 | 0.40 | 2.33 | 30 |
| S 40 | 2.22 | 0.27 | 0.40 | 2.33 | 40 |

Different brick paver samples were made at 10% brine, 20% brine, 30% brine and 40% brine (referred to as S 10, S 20, S 30, and S 40). The percentage of brine refers to the amount (by weight) of brine used to form the grey powder, relative to the amount of fly ash and kaolin used to form the grey powder. More specifically, the percentage of brine is based on the amount (by weight) of brine relative to a sum of brine, fly ash and kaolin in the powder.

The method by which the geopolymer brick pavers were made is as follows:

The raw materials, including fly ash, kaolin, and brine, were added to a multi-functional crusher from ARTC (model IC-5R2Q-8L80) in dry form. The crusher was run for 10 minutes, using the speed 1 knob at 100 rpm. This formed a homogeneous grey powder or cementitious powder. In the next step, the alkali activator solution (Na₂SiO₃/NaOH) was added to the cementitious powder. Specifically, the alkali activator solution was first added to a planetary mixer (Kenwood KMX760ABL) for wet mixing and then the cementitious powder was added to the planetary mixer. The combination of alkali activator and raw materials was continuously mixed in the planetary mixer for 10 minutes at speed 1 knob at 100 rpm to produce a uniformly mixed slurry or paste. To prevent air bubbles from accumulating in the viscous slurry, the planetary mixer was operated at a low speed. After mixing for 10 min, a smooth-lump free past-like slurry was formed.

The slurry was then cast in a polydimethylsiloxane (PDMS) hexagonal brick mold with dimensions of 45×45×45 mm. The mold containing the slurry mix was then manually compacted using a vibrating table. Two stages of curing were then performed. In the first stage, the resultant slurry was cured for six hours at room temperature. Following this, the brick specimen was subsequently de-molded from the casting mold and then cured in the second stage at 40° C. for three days. The result was brine-reinforced geopolymer brick paver samples (also referred to as brick paver samples) with the structure shown in FIGS. 3 and 4.

The brick paver samples were evaluated after an additional curing period of seven days at room temperature (approximately 28° C.). The brick paver samples (having a surface area of 16 cm²) were soaked in deionized water for 24 hours under stirring conditions at about 100 rpm.

The release of metal ions from the brick paver samples was analyzed by the following methods: American Public Health Association (APHA) 3120 b & 3030 e: 2017 23rd edition, APHA 4500-CL, HACH 8051 Edition 11, HACH 8029 Edition 10, and HACH 8171 Edition 09. The brine retention ability was calculated using Equation 1 below:

$$Brine rentention ability ( \% ) = \frac{{C}_{2} - {C}_{1}}{{C}_{2}} \times 100 \qquad ( 1 )$$

where C₁ represents the sodium chloride concentration (in ppm) released to water from brick paver samples, and C₂ represents the sodium chloride concentration (in ppm) in the brick paver samples.

In addition, the water absorption properties of the brick paver samples were examined using the gravimetric method and were calculated using Equation 2 below:

$$Water absorption ( \% ) = \frac{{W}_{2} - {W}_{1}}{{W}_{2}} \times 100 \qquad ( 2 )$$

where W₁ indicates the weight of samples after drying at 105° C., and W₂ indicates the weight of the sample after soaking for 24 h.

Moreover, overall stability was determined using Equation 3 below:

$$Overall stability ( \% ) = \frac{{W}_{a}}{{W}_{b}} \times 100 \qquad ( 3 )$$

where Wₐ specifies the sample weight after drying at 105° C., and W_{b} indicates the sample weight before soaking in water for 24 h.

Table 3 below presents the results of brine retention, water absorption, and overall stability of the brick paver samples. Remarkably, extended exposure to the aqueous medium did not lead to significant structural deterioration. Generally, water absorption is proportionally elevated with augmented brine incorporation. Despite the robust stability of all the brick paver samples, enhanced brine content correlated with reduced brine retention.

TABLE 3
Brine retention, water absorption and overall
stability of brick paver samples

| | Brine retention | Water | Overall |
|---|---|---|---|
| | ability | absorption | stability |
| SAMPLE | (%) | (%) | (%) |
| S 10 | 67.6 | 3.1 | 97 |
| S 20 | 71 | 7.5 | 96.7 |
| S 30 | 72.1 | 9.8 | 94.3 |
| S 40 | 55 | 14 | 85.1 |

Table 4 outlines potential leaching ions for the S 30 and S 40 samples. The leachate exhibited diverse monovalent and divalent cations and anions. Consequently, the sequence of ion retention in the brick matrix was: Mg>K>Ca>SO₄>Na>Cl. This showcases the intricate ion immobilization dynamics of the brick paver samples.

TABLE 4
Leachability test results of the S 30 and S 40 brick paver samples

| Parameter | Calcium | Magnesium | Sodium | Potassium | Chloride | Sulphate |
|---|---|---|---|---|---|---|
| (mg/L) | (Ca) | (Mg) | (Na) | (K) | (Cl) | (SO₄) |
| S 30 | 1.1 | 0.04 | 78.2 | <0.1 | 462 | 48 |
| S 40 | 0.9 | <0.002 | 165 | 1.47 | 746 | 28 |

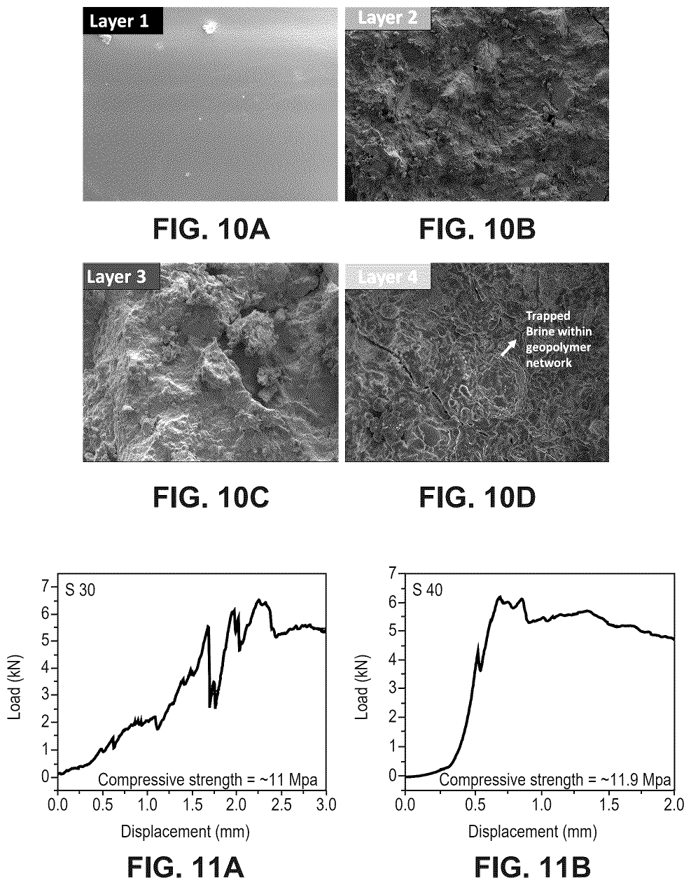

SEM analysis was conducted on the S 30 brick paver sample, utilizing a Quanta 250 SEM system (USA). FIGS. 10A-10D illustrates SEM images displaying the brick's morphology at different layers, including a surface layer (Layer 1 of FIG. 10A) and inner layers (Layers 2-4 in FIGS. 10B-10D, respectively).

The observation of compact morphology validates the comprehensive engagement of all raw materials in the geopolymerization process and the resulting structure of the geopolymer brick paver. Varied morphologies were observed, spanning from uniform to diverse. As depicted in FIGS. 10A-10D, gradual drying kinetics notably influence surface layer morphology, transitioning from outer to inner layers. This phenomenon leads to the creation of a uniform or densely compacted surface layer (FIG. 10A) due to initial surface exposure, while inner layers exhibit heterogeneity due to entrapped brine. See, for example, Layer 4 of FIG. 10D.

Following ASTM C109, compressive strength testing was performed on the S 30 and S 40 brick paver samples after a seven-day room temperature curing. The results for the S 30 sample are shown in FIG. 11A and the results for the S 40 sample are shown in FIG. 11B. Controlled moisture evaporation during curing yielded a peak strength of 12 N/mm², contributing to fewer structural voids.

The S 30 and S 40 brick paver samples qualify as first-class bricks according to the attributes detailed in Table 5 below. This affirms the durability and suitability of brine-reinforced geopolymer brick pavers for diverse applications, including, but not limited to, landscaping, walkways and construction.

TABLE 5
Various properties of the S 30 and S 40 brick paver samples

| Particulars | Brine-reinforced geopolymer brick | Result |
|---|---|---|
| Compressive | First-class brick (>105 kg/cm² or | Pass |
| Strength | 10.3 N/mm²), Brigeo brick has 12 N/mm² | |
| Shape & Size | Uniform hexagonal prism with sharp edges | Pass |
| | and corners. (a = 45 mm × h = 45 mm) | |
| Structure | Homogeneous, compact, and free from any | Pass |
| | defects such as holes, lumps. | |
| Water | Less than 14% | Pass |
| Absorption | (First-class bricks should not be | |
| | more than 15%) | |
| Color | Uniform grey | Pass |
| Hardness | No impression or scratch is found. | Pass |
| Soundness | Clear ringing sound when they struck | Pass |
| | each other. | |
| Impact test | It should not break when dropped | Pass |
| | from a one-meter height. | |
| Max. brine | 30-40% | Pass |
| loading (%) | | |
| Brine | ~70% | Pass |
| retention (%) | | |

As provided by the properties of Table 5, the brick paver samples offer enhanced mechanical robustness, water stability and longevity. These attributes can be efficiently managed through the establishment of a uniform or compacted surface layer using a geopolymerization process. Moreover, the geopolymer framework provides efficient containment of brine, further enhancing its efficacy and utility in diverse applications.

The scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A geopolymer composition comprising:
a three-dimensional (3D) alumino-silicates framework; and
brine embedded within the 3D alumino-silicates framework, wherein the geopolymer composition is formed through a molding process and the geopolymer composition exhibits high mechanical strength and water stability.

2. The geopolymer composition of claim 1, wherein the 3D alumino-silicates framework is formed by reacting silicon aluminum raw materials with an alkali activator solution.

3. The geopolymer composition of claim 2, wherein an amount of brine in the geopolymer composition is between about 10 and about 40 percent (by weight) relative to a sum (by weight) of brine and the silicon aluminum raw materials used to form the geopolymer composition.

4. The geopolymer composition of claim 3, wherein the amount of brine is between about 20 and about 30 percent.

5. The geopolymer composition of claim 2, wherein the silicon aluminum raw materials include fly ash and kaolin.

6. The geopolymer composition of claim 5, wherein a ratio (by weight) of fly ash to kaolin used to form the geopolymer composition is between about 2.30:1 and about 2.35:1.

7. The geopolymer composition of claim 2, wherein the alkali activator solution includes sodium hydroxide and sodium silicate.

8. The geopolymer composition of claim 7, wherein a ratio (by weight) of sodium silicate to sodium hydroxide in the alkali activator solution is between about 2.20:1 and about 2.25:1.

9. The geopolymer composition of claim 2, wherein a ratio (by weight) of alkali activator solution to the silicon aluminum raw materials is about 0.4:1.

10. The geopolymer composition of claim 2, wherein the reaction to form the 3D alumino-silicates framework includes water, and a ratio (by weight) of water to the silicon aluminum raw materials is between about 0.25:1 and about 0.30:1.

11. The geopolymer composition of claim 1, wherein the geopolymer composition is a brick paver for landscaping, sidewalks, driveways or walkways.

12. The geopolymer composition of claim 1, wherein the geopolymer composition is a miniature toy or decorative item.

13. A brick paver for landscaping or construction, the brick paver comprising:
a three-dimensional (3D) alumino-silicates framework; and
brine embedded within the 3D alumino-silicates framework, wherein the 3D alumino-silicates framework is formed by reacting fly ash and kaolin with an alkali activator solution.

14. The brick paver of claim 13, wherein an amount of brine in the brick paver is between about 10 and about 40 percent (by weight) relative to a sum (by weight) of brine, fly ash and kaolin used in forming the 3D alumino-silicates framework.

15. The brick paver of claim 13, wherein the alkali activator solution comprises sodium hydroxide and sodium silicate.

16. A method of making a geopolymer brick paver using solid brine waste, the method comprising:
creating a paste by combining solid brine waste, fly ash, kaolin and an alkali activator;
transferring the paste to a mold to solidify the paste into a solid material; and
curing the solid material to form the brick paver.

17. The method of claim 16, wherein the curing step includes a first curing stage at room temperature with the solid material remaining inside the mold and a second curing stage after the solid material is removed from the mold and at an elevated temperature.

18. The method of claim 16, wherein the method includes a sol-gel process.

19. The method of claim 16, wherein an amount of solid brine waste in the paste is between about 10 and about 40 percent (by weight) relative to a sum (by weight) of brine, fly ash and kaolin in the paste.

20. The method of claim 16, wherein a ratio (by weight) of fly ash to kaolin in the paste is between about 2.30:1 and about 2.35:1.
